(19) United States
(12) Patent Application Publication
(10) Pub. No.: US 2005/0231871 A1
(43) Pub. Date: Oct. 20, 2005

(54) Three-phase power signal processor

(76) Inventor: Masoud M. K. Karimi Ghartemani, Toronto (CA)

Correspondence Address: MILLER THOMPSON, LLP, 20 QUEEN STREET WEST, SUITE 2500, TORONTO, ON, M5H 3S1, CA

(21) Appl. No.: 11/098,421

(22) Filed: Apr. 5, 2005

(30) Foreign Application Priority Data
Apr. 5, 2004 (CA) 2,464,836

(51) Int. Cl. H02H 3/26

(52) U.S. Cl. 361/86

(57) ABSTRACT

A Three-phase Power Signal Processor (TPSP) is disclosed for general three-phase power system applications. The TPSP is developed based on the concepts from adaptive filter and dynamical systems theories. The structure of the TPSP is unified as it provides a multiplicity of the signals and pieces of information without the need to change, modify, or enhance the structure or to impose excessive computational time or resource requirements. The presented TPSP receives a set of three-phase measured signals, which can be voltage, current, magnetic flux, etc, and provides (1) the instantaneous and steady-state symmetrical components, (2) the fundamental components, (3) the peak values (magnitudes) of the symmetrical components, (4) the frequency and its rate of change, (5) the synchronization signal(s) and zero-crossing instants, (6) the phase-angles of the symmetrical components, and (7) the disturbance signatures. Two or more TPSP units, when properly augmented, further provide (8) the individual harmonic components, (9) the inter-harmonics, (10) the instantaneous real and reactive current components, (11) the total harmonic distortion, dc-offset, and power factor. The TPSP can serve as the building block for various signal processing requirements encountered in the context of power system applications including power systems control, protection, monitoring, and power quality.

### FIELD OF THE INVENTION

The present invention relates to signal processing algorithms, systems and circuits, and in particular, to signal processors for general three-phase power system applications.

### BACKGROUND OF THE INVENTION

Signal processing is a requirement in numerous applications in power systems. Operation of most power apparatuses is based on measurement of some physical quantity. For example, power flow controllers require accurate measurement for harmonics, reactive currents and unbalance signals. Power electronic converters generally require a precise synchronization signal for synchronizing the operation of their power electronic switches. Protection devices, such as relays, static transfer switch (STS) systems, and uninterruptible power supply (UPS) systems, generally require a reliable estimate of the frequency, rate of change of frequency, phase-angle, disturbance signature, or magnitude. Power quality measurement and monitoring devices such as power analyzers and signature systems need to accurately estimate harmonics, inter-harmonics, flicker measures, THD, power factor, imbalance, real/reactive powers etc.

In practice, voltage and current signals are measured and properly scaled using appropriate potential and current transformers and subsequently in most applications forwarded to a signal processing algorithm which obtains desired information from the measured and scaled signals. Desired performance of the signal processing algorithm is thus directly linked to the desired operation of the power apparatus. Recent advancements in the area of digital processing, which have resulted availability of high speed Digital Signal Processing (DSP) units as well as hardware based platforms such as Field Programmable Gate Array (FPGA) technology for implementing signal processing algorithms, initiated a new wave of interest in the development of new signal processing algorithms for power system applications. This is while the power system has also evolved to include sophisticated components, such as fast power electronic switches and renewable energy resources, which demand a new generation of signal processing algorithms to cope with the new conditions (including as further particularized below). An extensive amount of research and development in the area of signal processing as applied to power systems and power electronics has been carried out within the past two decades and the work still continues.

Fourier analysis is considered the most widely used signal processing algorithm for analysis of power system signals. Discrete/Fast Fourier Transform (DFT/FFT) is a digital algorithm which is used to analyze a distorted periodic signal and to estimate magnitudes and phase-angles of its constituting components. It is widely used in industrial power analyzers and phasor measurement units. The main reason for the wide publicity of this algorithm, and more precisely its recursively operating version, is its structural simplicity which has made its implementation on commercial DSP units relatively easy, so much so that most of the commercially available DSP units are currently tailored to accommodate the arithmetic required to perform the FFT. The DFT, however, suffers from shortcomings which especially limit its application to modern power systems. Most importantly, the DFT algorithm operates based on the presumption that the base frequency of the signal is known and fixed and also that the other constituting components are at the integer multiples of the base frequency. Moreover, the algorithm uses a window of data whose length must be both an integer multiple of the base period and an integer multiple of the sampling period. Thus, the DFT results are erroneous when any of these presumptions are violated, for example when the system frequency is varying in a weak power system, or when inter-harmonics with unknown frequencies are present and it is required that these be detected and analyzed. The DFT performs relatively well in the presence of environmental noise; however, it drastically loses its accuracy when the noise level is high. The DFT is an analysis tool and it does not synthesize any signals. Rather, for example, it estimates the magnitude and phase-angle of the fundamental component of a distorted signal but does not synthesize the actual fundamental component. This constitutes another limitation of the DFT in the context of those power system applications that require synthesized signals rather than parameters. Some of the technical references which address using DFT are [1-5] below under the heading “References”.

The dq0 transformation is another concept that is widely used for various power system applications. A three-phase set of signals is transformed to a new set of d, q and 0 signals that facilitate certain computations and analyses. This transformation requires a given phase-angle which is usually set to the phase-angle of the phase-a of the measured signal. This transformation is useful in decomposing the real and reactive components of the voltages, currents and powers. It is widely used for control of real and reactive power flow control based on use of power electronic converters. The concept of instantaneous reactive power is first presented based on the dq0 transformation and later is widely adopted for the compensation of reactive power using active power controllers. This technique is, however, sensitive to the voltage distortions and unbalance, and does not offer flexibility in controlling harmonics. Some references in this regard are [6-8] under the heading “References”.

Three-phase Phase-Locked Loop (3PLL) is a main component of major signal processing applications that require synchronization. Almost all power electronic converters that require synchronizing operation of their switches with the system's signals, use a 3PLL in their control scheme. The principle of operation of the 3PLL is based on performing a dq0 transformation (based on a given adjustable phase-angle) and then regulating the d component to zero to lock (this adjustable phase-angle) to the phase-angle of the phase-a system. The 3PLL, thus, provides an estimate of the phase-a phase-angle and also the frequency. It should be noted that this phase-angle is the total phase-angle and it is different from what is obtained by the DFT/FFT which is the constant phase-angle. Moreover, the 3PLL follows the variations in the base frequency of the system and its performance is robust with respect to noise and distortions. However, it loses its accuracy and ripples appear on the estimated parameters when the input signals are unbalanced. The 3PLL does not directly synthesize signals such as fundamental components or symmetrical components. A combination of DFT/FFT and 3PLL has been used in the literature to achieve this goal. The former estimates the magnitude and the latter estimates the total phase-angle and the required signals are synthesized based on these two variables. Such a system has a complex structure and lacks integrity. Some useful technical works in this regard are reported in [9-13] under the heading “References” below.

The concept of Kalman Filter (KF) has been introduced as an appropriate signal processing technique for certain power system applications such as frequency estimation, phasor measurement, etc. The KF is a digital adaptive filter which estimates the state variables of a system whose operation is modeled by a set of discrete state-space equations. If the representative model of the system is exact and the model parameters are exactly known and if the noise information is accurately known, then the KF is an optimal estimator which estimates the variables with minimum error. However, these conditions are far from being satisfied in realistic power systems in which signals exhibit complicated behaviors and need a high-order set of equations to model them, and even then the identification of the model parameters is also a tedious and relatively difficult task. Another problem with the KF algorithm is its sensitivity to the model parameters that renders it inoperative when the model is not exactly known. The KF algorithm is computationally demanding and has low degree of adjustability. Some related works in this regard are reported in [5, 14-17] under the heading “References” below.

Digital adaptive filtering has been presented as an alternative tool for analyzing power system signals. The well-known linear Least Mean Squares (LMS) technique, Least Squares (LS), Recursive LS (RLS) and Weighted LS (WLS) techniques have also been occasionally used for estimation of power system parameters. While performing well in some situations, these methods generally suffer from either dependence on an exact model for the signals or computational instability issues that limit their application to the more complicated power system scenarios. The concept of Neural Network (NN) and Artificial NN (ANN) is another tool that has been proposed for processing of power system signals. The main issues with this method are selection of appropriate neuron cells and layers to accurately model a realistic situation and also the difficulties with training the network. Some related works can be observed in [18-21] under the heading “References” below.

Several methods of a more or less heuristic nature have been presented in the technical literature for processing power system signals with respect to particular applications. Conventional 3PLL, for example, has been modified, by means of incorporating additional multiplication, integration and filtering units, to provide estimation of the magnitudes of the fundamental component and other harmonic components. The overall system is, thus, capable of synthesizing these desired components for active power flow control applications. Wavelet Transform (WT) has also been studied as an alternative signal analysis tool which, when compared with the DFT, provides a more flexible and more accurate analysis of the power system transients and disturbance signatures. One may examine [20-30] under the heading “References” below in this respect.

The main shortcomings of the existing signal processing systems, methods and related algorithms are particularly evident when considered in the context of modern power system applications. The conventional methods are operative in conventional power grids that are relatively “stiff”, with a fixed frequency, low level of noise and distortions, and well-behaved signals that can be modeled using relatively accurate models. Modern power systems, however, are no longer bound to exhibit well-behaved signals at fixed frequency and with low level of noise and distortions. This is mainly due to the high-density use of new power apparatuses such as switching power electronic equipment in compact industrial environments and also the proliferation of Distributed Energy Resource (DR) units due to the deregulation of the electric utility industry and also due to environmental issues. Conventional signal processing tools generally cannot cope with these conditions.

Also listed as [31-40] under the “References” section below are a number of papers published by the inventors of this disclosure related to the art.

There is a need therefore for a system and method for processing three-phase power system signals that operates in both conventional and modern power systems and that addresses the aforesaid accuracy problems. There is a further need for an improved system, method and related algorithm for signal processing that: (1) operate in both fixed and varying system frequency conditions; (2) operate independent of a signal model; (3) operate despite relatively high noise levels; and (4) are operable despite distortion (typically in the form of harmonics, inter-harmonics, transient medium- to high-frequency oscillatory signals); (5) take account of unbalanced scenarios; and (6) provide desirable adjustability and tuning features. A system and method is also needed that is feasible to implement using commercial software and hardware implementation platforms.

### SUMMARY OF THE INVENTION

In one aspect of the present invention a Three-phase Power Signal Processor (TPSP) is provided that is operable to receive a set of three-phase input (measured, properly scaled and communicated) signals and is operable to provide, in real-time (on-line), a plurality of outputs including the symmetrical components, fundamental components, harmonics, inter-harmonics, disturbance signatures, real/reactive currents, magnitudes of the real/reactive currents, frequency, rate of change of frequency, phase-angles of the symmetrical components, magnitudes of the symmetrical components, synchronization signal(s), total harmonic distortion (THD), power factor, and real/reactive powers. These outputs are then further used in numerous signal processing systems and the algorithms that are implemented by these signal processing systems, including in power system for control, protection, monitoring, and diagnostic functions in power systems.

In a more particular aspect of the system of the present invention a power system signal processor is provided that includes the TPSP.

The advantages of the system of the present invention include the relatively simple structure of the TPSP given its capabilities, its performance and structural robustness, operational adaptability and flexibility, and its multi-functionality. The range of applications of the present invention, thus particularly, encompasses those in which conventional filtering strategies, adaptive filtering techniques, phase-locked loop (PLL) systems, Fourier analysis (DFT and FFT), or similar tools and algorithms are employed. In general, the TPSP is applicable to any application wherein extraction, synthesis, or estimation of one or more of the aforementioned signals and pieces of information is desired.

In yet another aspect of the present invention a method for processing three-phase power signals is provided based on a plurality of signal processing algorithms described in this disclosure and applied to the TPSP. The method generally obviates the shortcomings of conventional methods and related algorithms, namely sensitivity to frequency variations, being based on signal's model, sensitivity to noise, distortions, unbalanced signals, lack of adjustability and tuning, and computational complexity and instability.

In a still other aspect of the present invention a method and related algorithm is provided that accommodates varying frequency conditions, analyzes inter-harmonics, and synthesizes the highly useful signals for power system applications, such as instantaneous symmetrical components and fundamental components.

The present invention is operable to synthesize the instantaneous symmetrical components and the fundamental components, and is further operable to estimate their magnitudes and phase-angles. The invention is also operable to provide improved accuracy in its results in the presence of voltage distortions and unbalance, adaptivity to frequency variations, and to provide flexibility in extracting the instantaneous reactive current components and harmonics separately.

Thus, the proposed method operates in both fixed and varying frequency conditions, its operation is not based on any model of the measured signals, its performance is highly immune to the presence of noise and distortions, it takes full account of unbalanced conditions, its structure is integral and it can be readily implemented on commercial software and hardware platforms, and it inherits desirable tuning and adjustment properties due to its simple and unified structure as well as the direct correspondence of its estimated variables to the physical quantities of the system or attributes of the signals.

### BRIEF DESCRIPTION OF THE DRAWINGS

In the accompanying drawings like reference numbers denote like components, brief description of which is herewith given.

FIG. 1 shows the structural block diagram of the TPSP system. The thick connection lines are used to show three-phase connections and the thin connection lines show single-phase connections.

FIG. 2 shows the structural block diagram of the extension of the TPSP for extracting reactive current components.

FIG. 3 shows a diagram giving guidelines for the design of the parameters of the TPSP based on the concept of pole placement.

FIG. 4 shows, by way of example, an input signal used to illustrate the TPSP initial behavior.

FIG. 5 illustrates, by way of example, the performance of the present TPSP in extracting the fundamental components.

FIG. 6 illustrates, by way of example, the performance of the present TPSP in extracting the instantaneous positive-sequence components.

FIG. 7 illustrates, by way of example, the performance of the present TPSP in extracting the instantaneous negative-sequence components.

FIG. 8 illustrates, by way of example, the performance of the present TPSP in extracting the instantaneous zero-sequence component.

FIG. 9 illustrates, by way of example, the performance of the present TPSP in estimating the magnitudes of the positive-, negative- and zero-sequence components.

FIG. 10 illustrates, by way of example, the performance of the present TPSP in estimating the phase-angles of the negative- and zero-sequence components with reference to the phase-angle of the positive-sequence components.

FIG. 11 illustrates, by way of example, the performance of the present TPSP in estimating the system frequency.

FIG. 12 illustrates, by way of example, the performance of the present TPSP in tracking and estimating multiple step changes in the magnitude of the positive-sequence components.

FIG. 13 illustrates, by way of example, the performance of the present TPSP in tracking and estimating multiple step changes in the magnitudes of the negative- and zero-sequence components.

FIG. 14 illustrates, by way of example, the performance of the present TPSP in tracking and estimating multiple small step changes in the frequency of the system.

FIG. 15 illustrates, by way of example, the performance of the present TPSP in tracking and estimating multiple large step changes in the frequency of the system.

### DETAILED DESCRIPTION OF THE PREFERRED EMBODIMENT

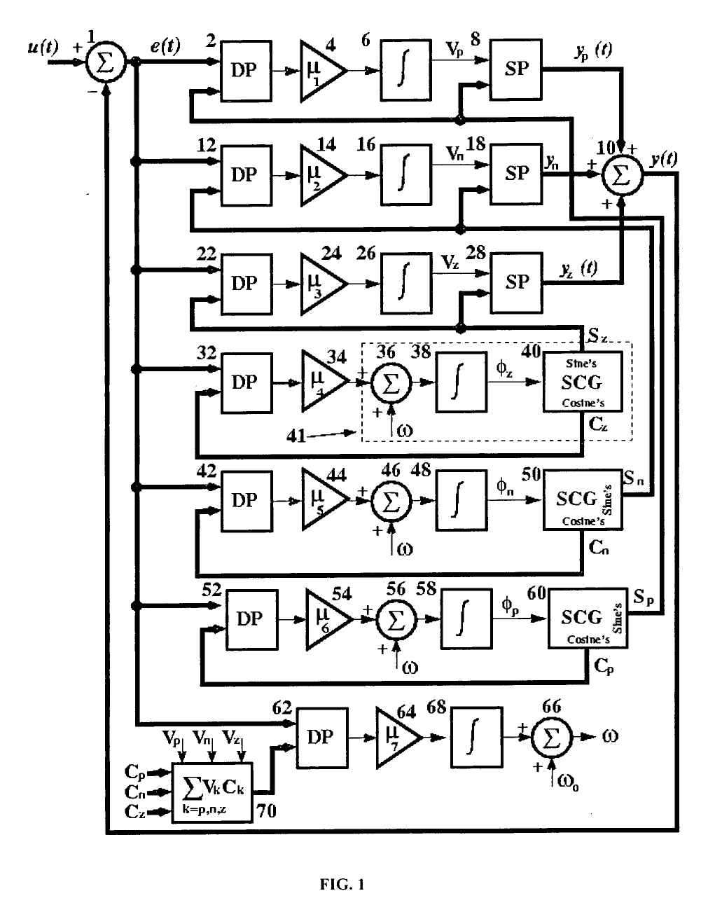

With reference to the accompanying drawings and in particular to FIG. 1, the TPSP (10) system of the invention includes a plurality of components, namely circuits and system components or signal processing operations, as described below. The subtraction unit (1) subtracts the input signals U(t) from the output signals Y(t) of the TPSP (10). The output signal Y(t) consists of the estimated fundamental components of the input signal which is made available by the TPSP (10). The generated signal by the subtraction (1), E(t), is called the error signal which constitutes the totality of all the distortion and noise present on the input signal.

The TPSP (10) is graphically represented by seven branches as drawn in FIG. 1. A functional description of each one, in the order from top to bottom of FIG. 1, is as follows. It is obvious to any person familiar with the concepts of circuits and systems and signal processing that various versions of the block-representation given by FIG. 1 can be derived. We confine ourselves to the representation of FIG. 1 without loss of generality and to simplify the description of the TPSP (10). In this way, FIG. 1 illustrates the functions of the TPSP rather than a particular structure therefore.

The first branch from top estimates the magnitude Vp and synthesizes the instantaneous values Yp(t) of the positive-sequence components.

The second branch estimates the magnitude Vn and synthesizes the instantaneous values Yn(t) of the negative-sequence components.

The third branch estimates the magnitude Vz and synthesizes the instantaneous values Yz(t) of the zero-sequence components.

The fourth branch estimates the phase-angle Φz of the zero-sequence components and synthesizes two zero sine Sz and cosine Cz signals.

The fifth branch estimates the phase-angle Φn of the negative-sequence components and synthesizes two negative sine Sn and cosine Cn signals.

The sixth branch estimates the phase-angle Φp of the positive-sequence components and synthesizes two positive sine Sp and cosine Cp signals.

The seventh branch estimates the frequency ω.

In the drawing of FIG. 1, the DP blocks (2), (12), (22), (32), (42), (52) and (62) are identical and the function of each DP unit is to perform a three-phase vector dot-product <X,Y>=x1y1+x2y2+x3y3; hence it is equivalent to three scalar products plus two scalar additions.

The SP blocks (8), (18) and (28) are identical and perform a scalar-into-vector product as cX wherein c stands for a scalar and X stands for a three-dimensional vector; hence it is equivalent to three scalar multiplications.

The block (4) is a scalar gain block and corresponds to the positive-sequence magnitude and its value is denoted by μ1. This block (4) is driven by the output of the DP block (2). The DP block (2) performs the dot-product of the error signal E and the positive sine signal Sp.

The estimated magnitude of the positive-sequence components is provided at the output terminal of the scalar integrator block (6) that is located after the first gain block (4). The positive-sequence components are synthesized by and made available at the outputs of the SP block (8) that multiplies the positive-sequence magnitude into the positive sine signals Sp. The block (14) is a second scalar gain block and corresponds to the negative-sequence magnitude and its value is denoted by μ2. This block is driven by the output of the DP block (12). The DP block (12) performs the dot-product of the error signal E and the negative sine signal Sn. The estimated magnitude of the negative-sequence components is provided at the output terminal of the scalar integrator block (16) that is located after the second gain block (14). The negative-sequence components are synthesized by and made available at the outputs of the SP block (18) that multiplies the negative-sequence magnitude into the negative sine signals Sp.

The block (24) is a third scalar gain block and corresponds to the zero-sequence magnitude and its value is denoted by μ3. This block is driven by the output of the DP block (22). The DP block (22) performs the dot-product of the error signal E and the zero sine signal Sz. The estimated magnitude of the zero-sequence components is provided at the output terminal of the scalar integrator block (26) that is located after the third gain block (24). The zero-sequence components are synthesized by and made available at the outputs of the SP block (28) which multiplies the zero-sequence magnitude into the zero sine signals Sz. The summation (10) is a three-dimensional three-input unit which adds the instantaneous positive-sequence components Yp(t), negative-sequence components Yn(t), and zero-sequence components Yz(t), respectively made available at the output terminals of the SP units (8), (18) and (28), and provides the fundamental components Y(t) which are subsequently used in the subtraction unit 1 to generate the error signal E(t).

In the drawing of FIG. 1, the sixth branch estimates the phase-angle of the positive-sequence components and synthesizes the positive sine Sp and cosine Cp signals. The DP unit (52) performs the dot-product of the error signal E and the positive cosine signal Cp. Its output is then passed through the sixth gain block (54), whose value is μ6 and, whose output is subsequently added, by addition unit (56), with the estimated frequency. The result of this addition is forwarded to the integration unit (58) whose output is the estimated phase-angle of the positive-sequence components. The block SCG (60) receives the estimated positive-sequence phase-angle Φp and generates two positive sine and cosine signals as defined by:
Sp=[ sin(Φp), sin(Φp−2π/3), sin(Φp+2π/3)]
and
Cp=[ cos(Φp), cos(Φp−2π/3), cos(Φp+2π/3)].

The signal Sp is forwarded to the DP (2) and SP (8) and the signal Cp is forwarded to the DP unit (52).

The fifth branch in FIG. 1 estimates the phase-angle of the negative-sequence components and synthesizes the negative sine and cosine signals. The DP unit (42) performs the dot-product of the error signal E and the negative cosine signal Cp. Its output is then passed through the fifth gain block (44), whose value is μ5 and, whose output is subsequently added, by addition unit (46), with the estimated frequency. The result of this addition is forwarded to the integration unit (48) whose output is the estimated phase-angle of the negative-sequence components. The SCG (50) receives the phase-angle (On and generates two negative sine and cosine signals as defined by:
Sn=[ sin(Φn), sin(Φn+2π/3), sin(Φn−2π/3)]
and
Cn=[ cos(Φn), cos(Φn+2π/3), cos(Φn−2π/3)].

The signal Sn is forwarded to the DP unit (12) and to the SP unit (18), and the signal Cn is forwarded to the DP unit (42).

The fourth branch in FIG. 1 estimates the phase-angle of the zero-sequence components and synthesizes the zero sine and cosine signals. The DP unit (32) performs the dot-product of the error signal E and the zero cosine signal Cz. Its output is then passed through the fourth gain block (34), whose value is μ4 and, whose output is subsequently added, by addition unit (36), with the estimated frequency. The result of this addition is forwarded to the integration unit (38) whose output is the estimated phase-angle of the zero-sequence components. The SCG (40) receives the phase-angle (z and generates two zero sine and cosine signals as defined by Sz=[ sin(Φz), sin(Φz), sin(Φz)] and Cz=[ cos(Φz), cos(Φz), cos(Φz)]. The signal Sz is forwarded to the DP unit (22) and SP unit (28) and the signal Cz is forwarded to the DP unit (32).

The seventh branch in FIG. 1 performs the frequency estimation. The block (70) receives the estimated magnitudes of the three positive-, negative- and zero-sequence components, Vp, Vn and Vz, and the positive, negative and zero cosine signals, Cp, Cn, and Cz, and performs a sum-of-scalar-into-vector products as expressed by VpCp+VnCn+VzCz. The result of this operation is then forwarded to the DP unit (62) and is dot-producted with the error signal E. The output of the DP unit (62) is scaled using the gain (64) whose value is μ7 and forwarded to the integration unit (68). The output of this unit is an estimate of the frequency deviation from the nominal value of the frequency and thus its input will be an estimate for the rate of change of frequency. The addition unit (66) adds this output value to the nominal value of frequency and provides an estimate of the frequency.

The aggregation of units (36), (38) and (40) constitutes the unit (41), which receives its driving signal from the gain (34) and provides the positive sine and cosine signals Sp and Cp. This unit (41) is a generalization of the known circuit component, which is technically called Voltage-Controlled Oscillator (VCO), and there are ways of implementing this component using analog, digital or hybrid circuits in the technical literature. Similarly, the aggregation of units (46), (48), and (50), and (56), (58) and (60), can be provided as two VCOs with minor differences. The VCO is a major component of the Phase-Locked Loop (PLL) systems. It should be understood that conventional PLL only locks into a single phase-angle, locks into three phase-angles and three magnitudes of the instantaneous symmetrical components, in contrast to the TPSP (10) of the present invention.

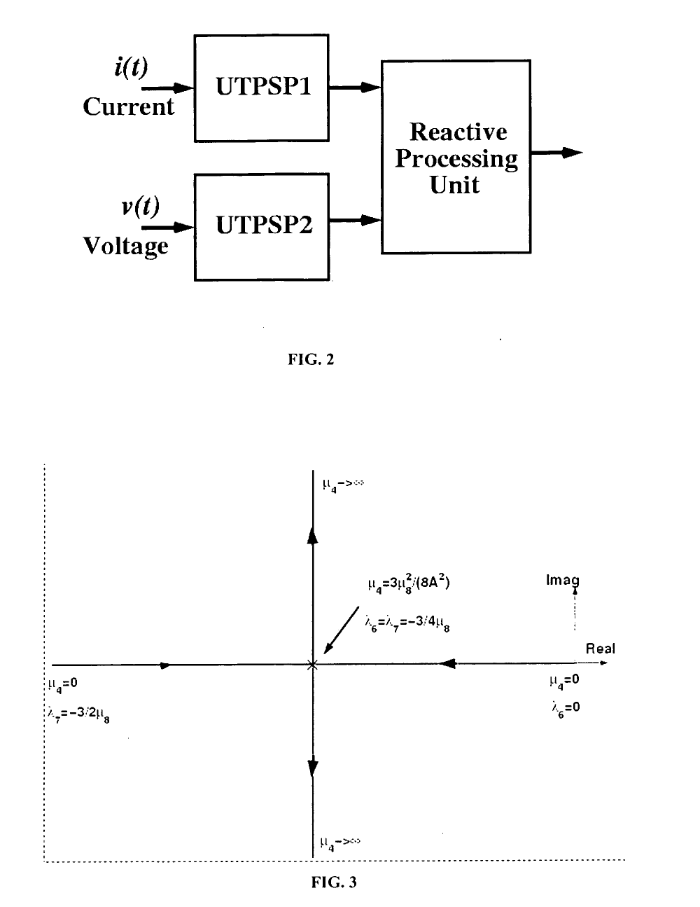

The proposed TPSP of this invention extracts the fundamental component of the input signal and then decomposes this fundamental component into its constituting symmetrical (or sequence) components. Moreover, it provides an estimate of the signal attributes for all these components. With these signals and pieces of information, the positive-sequence of the current signal can further be decomposed into two components: one which is in-phase with the voltage signal and the other which is orthogonal to the voltage signal. The component that is orthogonal to the voltage signal is called the reactive component of current. FIG. 2 shows an embodiment to realize this concept and to obtain the instantaneous reactive current component. The Reactive Current Processing unit (80) in FIG. 2 carries out this task.

Therefore the controlling parameters of the TPSP are the seven gain values based on which the speed and accuracy of the results are determined. The gain (2) controls the speed/accuracy of the positive-sequence magnitude. The gain (12) controls the speed/accuracy of the negative-sequence magnitude. The gain (22) controls the speed/accuracy of the zero-sequence magnitude. These three gains can be adjusted independently of each other and of other parameters and without any dependence on the input signal magnitude. The gains (32), (42), (52) and (62) control the speed/accuracy of the phase-angles and frequency of the three sequence-components. These are mutually dependent on each other and on the magnitude and the degree of the unbalance of the input signal. There are ways of determining these parameters to achieve a desirable performance of the TPSP (10) based on the specifications required by applications. One method is based on the concept of pole placement, which is symbolically sketched in FIG. 3.

In adjusting the controlling parameters of the TPSP (10), there is always a trade-off between the speed and the error incurred in the estimated values. To improve such a trade-off one can insert low-pass filters at the appropriate locations in the TPSP (10). Particularly, a totality of seven or fewer number of low-pass filters can be inserted before or after the integration units in each branch. The low-pass filters must be carefully selected to smooth out the estimated values while not introducing significant delay in the responses.

### INDUSTRIAL APPLICABILITY

The preferred embodiment of the present invention described herein provides the important information regarding the applicable fundamental components and their constituting symmetrical components. The first outputs of the system are the outputs of the addition unit (10). These outputs estimate the fundamental components of the input signal. The output signals of the SP unit (8) estimate the instantaneous positive-sequence components at the fundamental frequency. The output signal of the integration block (6) estimates the magnitude of the instantaneous positive-sequence components. The output signal of the integration unit (58) estimates the total phase-angle of the phase-a of the positive-sequence components. The output signals of the SP unit (18) estimate the instantaneous negative-sequence components at the fundamental frequency. The output signal of the integration block (16) estimates the magnitude of the instantaneous negative-sequence components. The output signal of the integration unit (48) estimates the total phase-angle of the phase-a of the negative-sequence components. The output signals of the SP unit (28) estimate the instantaneous zero-sequence components at the fundamental frequency. The output signal of the integration block (26) estimates the magnitude of the instantaneous zero-sequence components. The output signal of the integration unit (38) estimates the total phase-angle of the zero-sequence components. The output signal of the integration unit (68) estimates the frequency.

It should be noted that the stationary symmetrical components, conventionally defined based on the concept of phasors, are also estimated by the preferred embodiment of the invention. The estimated magnitudes, as described above, coincide with the magnitudes of the stationary symmetrical components. Taking the positive-sequence phase-angle as the reference and subtracting the other two phase-angles from the reference value then obtains the phase-angles of the stationary symmetrical components. Finally, the input signal of each integration unit described above estimates the rate of change of the corresponding variable (three magnitudes, three phase-angles and frequency). Therefore, in the present invention, in addition to the fact that the synthesized output signals (including the fundamental components and the symmetrical components) are in amplitude/phase-angle/frequency locked with the actual values of their input signal, the values of magnitudes, phase-angles, and frequency are also directly available.

One of the advantages of the present invention is that the TPSP is operable to provide a relatively large number of signals and pieces of information which are frequent requirements in various practical applications in the wide sub-areas of power systems engineering. This is while its structure remains unified, simple and easily implementable using analog and digital circuitries. Moreover, its adjustment and control of its behaviors are easy to perform due to the direct correspondence of the adjusting parameters with the physical quantities. Root locus technique and the concept of pole placement are extended to the adjustment of the parameters of the TPSP. One further significant feature of the TPSP is its highly noise-immune performance which is a desirable factor in the modern power systems.

A number of graphs are presented to aid in understanding the basic performance of the TPSP.

FIG. 4 shows, by way of example, an unbalanced input signal which is applied to the TPSP for performance evaluation.

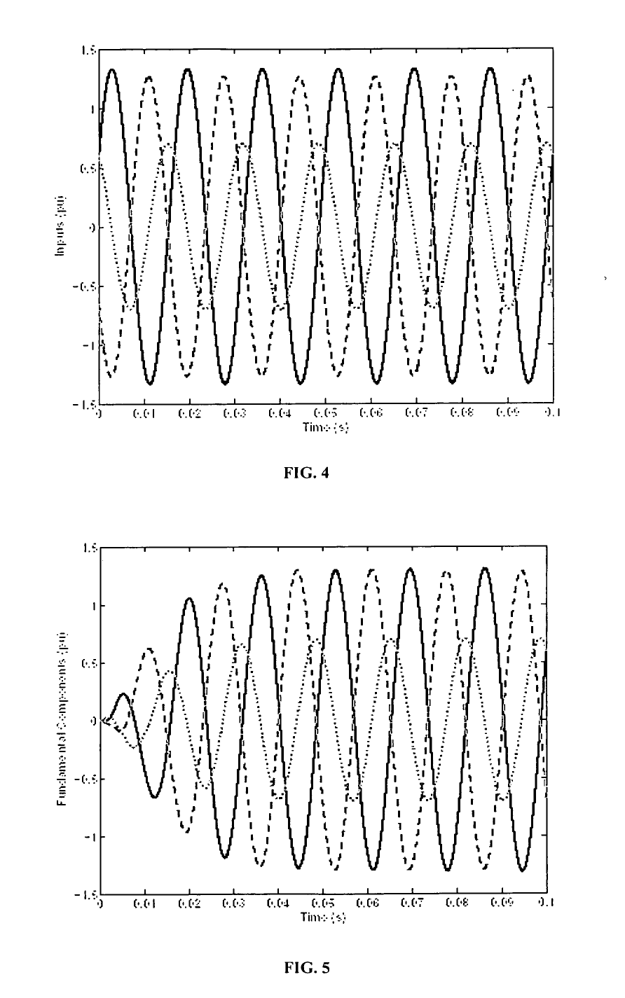

FIG. 5 shows the performance of the TPSP in synthesizing the fundamental components of the unbalanced input signal shown in FIG. 4. The initialization behavior is specifically shown which shows a fast and accurate extraction of the fundamental components.

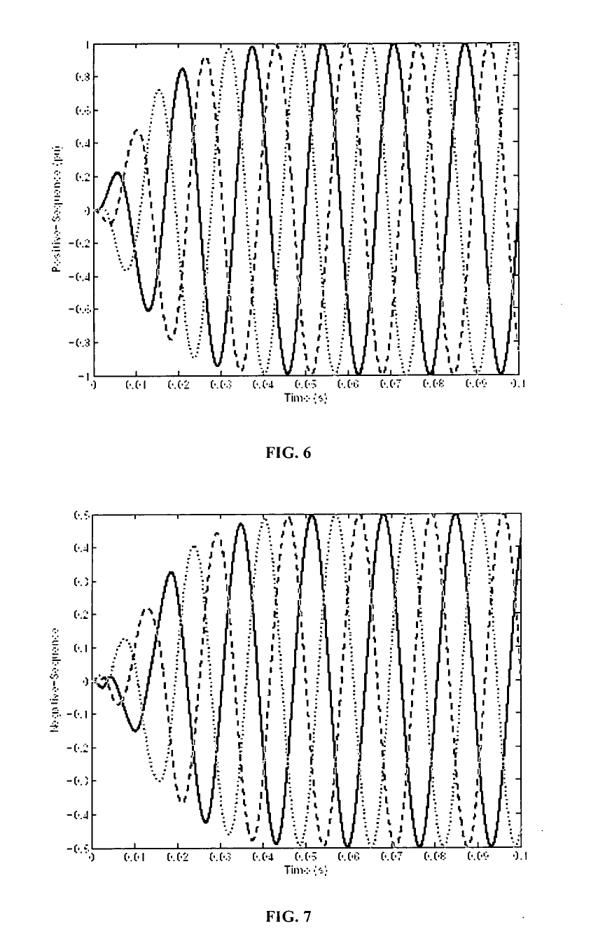

FIG. 6 shows, by way of example, the performance of the TPSP in synthesizing the instantaneous positive-sequence components of the input signal of FIG. 4. These components are accurately provided by the TPSP.

FIG. 7 shows the performance of the TPSP in synthesizing the instantaneous negative-sequence components of the input signal of FIG. 4. These components are also accurately provided by the TPSP.

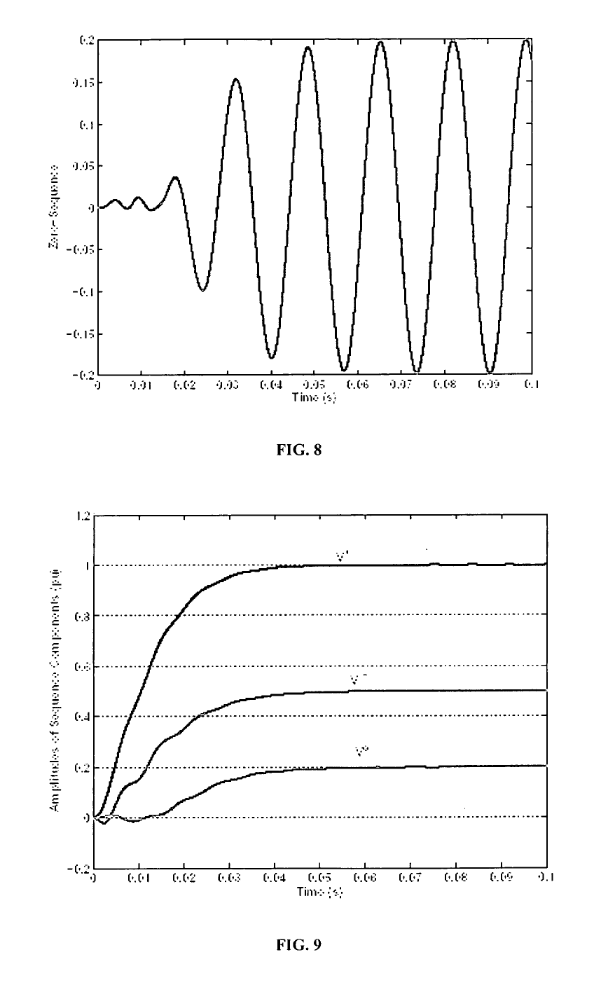

FIG. 8 shows the performance of the TPSP in synthesizing the instantaneous zero-sequence component of the input signal of FIG. 4. This component is also accurately provided by the TPSP.

FIG. 9 shows the performance of the TPSP in estimating the magnitudes of the sequence components. All three magnitudes are accurately estimated, as 1, 0.5 and 0.2 respectively for positive-, negative- and zero-sequence components, by the TPSP.

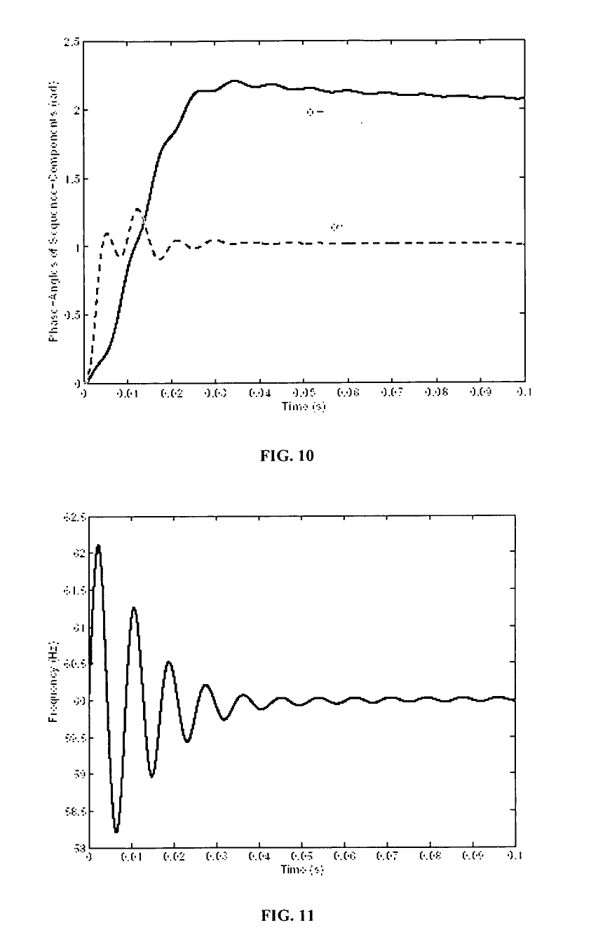

FIG. 10 shows the performance of the TPSP in estimating the phase-angles of the sequence components. Only the phase-angles of the negative- and zero-sequence components, when referenced to the phase-angle of the positive-sequence components, are provided for a better visualization of the estimated phase-angles. The phase-angles are accurately estimated by the TPSP.

FIG. 11 shows the performance of the TPSP in estimating the frequency. The frequency is accurately estimated, to be 60 Hz, by the TPSP.

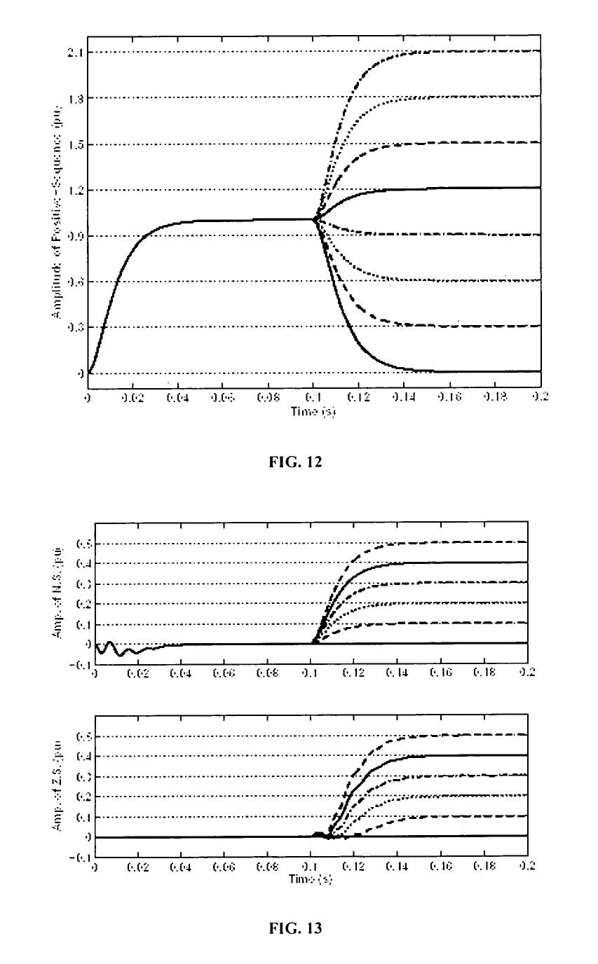

FIG. 12 shows the performance of the TPSP when multiple step changes in the amplitude of the positive-sequence components occur. The changes as big as 100% of the nominal value are applied. It is observed that the TPSP is robust to adapt itself to the new values of amplitudes and to estimate the amplitudes accurately.

FIG. 13 shows the performance of the TPSP when multiple step changes in the amplitude of the negative-sequence or zero-sequence components occur. It is observed that the TPSP is robust to adapt itself to the new values of amplitudes of both sequence components and to estimate the new amplitudes accurately.

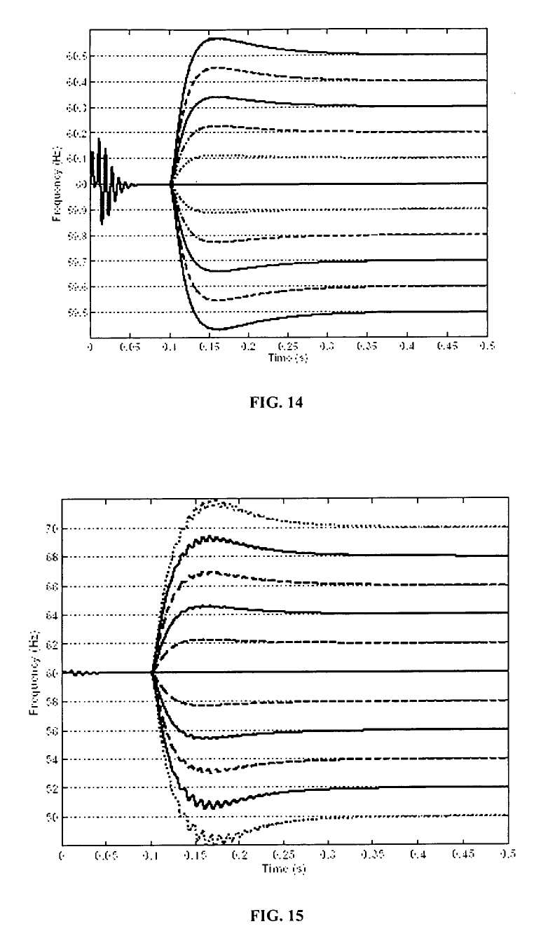

FIG. 14 shows the performance of the TPSP when multiple small step changes in the frequency of the system occur. The changes from −0.5 Hz to 0.5 Hz with a resolution of 0.1 Hz are applied. It is observed that the TPSP is robust to adapt itself to the new values of frequency and to estimate the new values accurately.

FIG. 15 shows the performance of the TPSP when multiple large step changes in the frequency of the system occur. The changes from −10 Hz to 10 Hz with a resolution of 2 Hz are applied. It is observed that the TPSP is robust to adapt itself to the new values of frequency and to estimate the new values accurately.

Method

The method is best understood as a method of analyzing and synthesizing a number of signals and related signal parameters by processing a set of three-phase input signals using the TPSP.

A method of analyzing and synthesizing a plurality of signals and their signal parameters associated with a system is provided that includes:
(1) deriving the synthesized fundamental component of an input signal so as to determine an output signal;
(2) determining the difference between the input signal and an output signal, so as to derive an error signal;
(3) driving a signal processor using the error signal;
(4) estimating the magnitudes of the instantaneous symmetrical or sequence components of said first input signal, and synthesizing said symmetrical or sequence components;
(5) estimating the phase-angles of the instantaneous sequence components of said first input signal;
(6) synthesizing the sine and cosine signals;
(7) estimating the frequency of the system;
(8) estimating the phase-angles; and
(9) adding the instantaneous sequence components to provide the output signal as an output.

In another aspect of the invention, the method includes the steps of:
(1) Providing to the TPSP a plurality of signals consisting of: (i) an instantaneous positive-sequence component (three signals), (ii) an instantaneous negative-sequence component (three signals), (iii) an instantaneous zero-sequence component (one signal), a plurality of fundamental components (three signals), and (iv) the harmonics and distortions present on the input signals (three signals);
(2) Decomposing the fundamental components of the plurality of signals to determine their constituting symmetrical or sequence components;
(3) Estimating or synthesizing the following signal attributes for the plurality of signals by operation of the TPSP: (i) a magnitude of the positive-sequence component, (ii) a rate of change of the magnitude of the positive-sequence component, (iii) a magnitude of the negative-sequence component, (iv) a rate of change of the magnitude of the negative-sequence component, (v) a magnitude of the zero-sequence component, (vi) a rate of change of the magnitude of the zero-sequence component, (vii) a phase-angle of the positive-sequence component, (viii) a phase-angle of the negative-sequence component, (ix) a phase-angle of the zero-sequence component, (x) a frequency, and a (xi) rate of change of the frequency; and

Therefore the proposed TPSP extracts the fundamental component of the input signal and then decomposes this fundamental component into its constituting symmetrical (or sequence) components. Moreover, it provides an estimate of the signal attributes for all these components. With these signals and pieces of information, the positive-sequence of the current signal can further be decomposed into two components: one which is in-phase with the voltage signal and the other which is orthogonal to the voltage signal. The component that is orthogonal to the voltage signal is called the reactive component of current. FIG. 2 shows an embodiment to realize this concept and to obtain the instantaneous reactive current component. The Reactive Current Processing unit (80) in FIG. 2 carries out this task.

In another aspect of the method of the present invention, other signals and additional information are provided to the TPSP indirectly by linking the TPSP to one computation units, in a manner that is known, so as to enable the TPSP to process the functions such as additions, multiplications, trigonometric functions, and integration units.

Examples of these signals and additional information include total harmonic distortion (THD), imbalance index, and measures for flicker. In this particular aspect of the present invention, two units of the TPSP are properly connected, one is driven by the voltage signals and the other with current signals, to extract the instantaneous reactive current components (three signals). The operational accuracy of this particular embodiment of the present invention for extraction of reactive currents is independent of the voltage distortions and unbalanced conditions. This structure also estimates the power factor, the average real power, reactive power and other measures of power. Multiple units of the TPSP are used to identify and extract higher order harmonics and inter-harmonics by locating their frequencies, estimating their magnitudes and phase-angles, and extracting their instantaneous values. In this structure, each unit is equipped with a saturation block to bound the operation of each unit to a pre-specified range of frequency within which the desired component is sought.

Advantageously, the performance of the TPSP in terms of the speed of convergence and admissible error is fully controlled by means of the adjustment of several parameters. Three of these parameters directly and almost independently control the speeds of convergence of magnitudes of the positive-, negative- and zero-sequence components. The rest four parameters provide direct but coupled control over speeds of convergence of phase-angles of the three sequence components and the frequency. In the TPSP, the direct correspondence between each parameter and a physically meaningful variable, such as magnitude, phase-angle and frequency, provides the designer with an easy yet powerful means of determination of the behavior of the system for different applications. Guidelines for the design of parameters of the TPSP are developed and are available.

The present invention can deployed in industries that utilize power electronics including but not limited to the utility industry, aerospace industry, automotive industry, traction industry, power supply industry, energy generation and storage industry, motion control and drive industry. More specific examples are Flexible AC Transmission Systems (FACTS) and Custom Power Controllers, such as Active Power Filter (APF), Static Compensator (STATCOM), and other types of Power Flow Controller (PFC) schemes. The TPSP can particularly serve as an integral part of the control system of the technology of Distributed energy Resources (DRs). Power analyzer and signature systems constitute further applications of the TPSP in the context of power quality measurement and monitoring. Adaptive operation, immunity to noise, structural and performance robustness are salient features of the TPSP.

### REFERENCES

[1] B. G. Quinn, “Estimation of Frequency, Amplitude, and Phase from the DFT of a Time Series,” IEEE Transactions on Signal Processing, Vol. 45, No. 3, March 1997, pp. 814-817.
[2] J-Z. Yang and C-W. Liu, “A Precise Calculation of Power System Frequency,” IEEE Transactions on Power Delivery, Vol. 16, No. 3, July 2001, pp. 361-366.
[3] A. G. Phadke, J. S. Thorp, and M. G. Adamiak, “A New Measurement Technique for Tracking Voltage Phasors, Local System Frequency, and Rate of Change of Frequency,” IEEE Transactions on Power Apparatus and Systems, Vol. 102, No. 5, May 1983, pp. 1025-1038.
[4] J. P. Benco et al, “Generator Protection System and Method for Phasor Estimation and Frequency Tracking During Frequency Ramping,” U.S. Pat. No. 5,832,413, Nov. 13, 1998.
[5] I. Kamwa, R. Grondin and D. Mcnabb, “On-Line Tracking of Changing Harmonics in Stresses Power Systems: Application to Hydro-Quebec Networks,” IEEE Transactions on Power Delivery, Vol. 11, No. 4, October 1996, pp. 2020-2027.
[6] H. Akagi, “New Trends in Active Filters for Power Conditioning,” IEEE Transactions on Industry Applications, Vol. 32, No. 6, 1996, pp. 1312-1322.
[7] T. Tanaka and H. Akagi, “A new method of harmonic power detection based on the instantaneous active power in three-phase circuits,” IEEE transactions on power delivery, 1995, Vol. 10, No. 4, pp. 1737-1742.
[8] A. Nabae and T. Tannaka, “A new definition of instantaneous active-reactive current and power based on instantaneous space vectors on polar coordinates in three-phase circuits,” IEEE transactions on power delivery, 1996, vol. 11, No. 3, pp. 1238-1243
[9] S. K. Chung, “A phase tracking system for three phase utility interface inverters,” IEEE Transactions on Power Electronics, Vol. 15, No. 3, pp. 431-438, 2000.
[10] V. Kaura and V. Blasko, “Operation of a phase locked loop system under distorted utility conditions,” IEEE Transactions on Industry applications, Vol. 33, No. 1, pp. 58-63, 1997.
[11] H. Li, F. Zhuo, L. Wu, W. Lei, J. Liu and Z. Wang, “A Novel Current Detection Algorithm for Shunt Active Power Filters in Harmonic Elimination, Reactive Power Compensation and Three-Phase Balancing,” Proceedings of the 35th annual IEEE Power Electronics Specialists Conference (PESC), Aachen, Germany, 2004, pp. 1017-1023.
[12] R. Hao, Z. Cheng and X. You, “A Novel Harmonic Currents Detection Method Based on Rotating d-q Reference Frame for Active Power Filter,” Proceedings of the 35th annual IEEE Power Electronics Specialists Conference (PESC), Aachen, Germany, 2004, pp. 3034-3038.
[13] K. P. Sozanski, “Harmonic Compensation Using the Sliding DFT Algorithm,” Proceedings of the 35th annual IEEE Power Electronics Specialists Conference (PESC), Aachen, Germany, 2004, pp. 4649-4653.
[14] A. A. Girgis and W. L. Peterson, “Adaptive estimation of power system frequency deviation and its rate of change for calculating sudden power system overloads,” IEEE Transactions on Power Delivery, Vol. 5, No. 2, pp. 585-594, 1990.
[15] A. Routary, A. K. Pradhan, K. P. Rao, “A novel Kalman filter for frequency estimation of distorted signals in power systems,” IEEE Transactions on Instrumentation and Measurement, Vol. 51, No. 3, June 2002, pp. 469-479.
[16] H. M. Beides, and G. T. Heydt, “Dynamic state estimation of power system harmonics using Kalman filter methodology,” IEEE Transactions on Power Delivery, Vol. 6, No. 4, October 1991, pp. 1663-1670.
[17] P. K. Dash, P. K. Jena, G. Panda and A. Routary, “An extended complex Kalman filter for frequency measurement of distorted signals,” IEEE Transactions on Instrumentation and Measurement, Vol. 49, No. 4, August 2000, pp. 746-753.
[18] H. S. Song and K. Nam, “Instantaneous phase-angle estimation algorithm under unbalanced voltage-sag conditions,” IEE Proceedings on Generation, Transmission, and Distribution, Vol. 147, No. 6, pp. 409-415, 2000.
[19] J. Q. Zhang, Z. Xinmin, H. Xiao, and S. Jinwei, “Sinewave Fit Algorithm Based on Total Least-Squares Method with Application to ADC Effective Bits Measurement,” IEEE Transactions on Instrumentation and Measurement, Vol. 46, No. 4, August 1997, pp. 1026-1030.
[20] I. Kamwa and R. Grondin, “Fast Adaptive Schemes for Tracking Voltage Phasor and Local frequency in Power Transmission and Distribution Systems,” IEEE Transactions on Power Delivery, Vol. 7, No. 2, April 1992, pp. 789-795.
[21] L. L. Lai, W. L. Chan, C. T. Tse, A. T. P. So, “Real-Time Frequency and Harmonic Evaluation Using Artificial Neural Networks,” IEEE Transactions on Power Delivery, Vol. 14, No. 1, January 1999, pp. 52-59.
[22] D. W. P. Thomas and M. S. Woolfson, “Evaluation of Frequency Tracking Methods,” IEEE Transactions on Power Delivery, Vol. 16, No. 3, July 2001, pp. 367-371.
[23] M. V. Ribeiro, J. M. T. Romano and C. A. Duque, “An Improved Method for Signal Processing and Compression in Power Quality Evaluation,” IEEE Transactions on Power Delivery, Vol. 19, No. 2, April 2004, pp. 464-471.
[24] V. V. Terzija, M. B. Djuric, and B. D. Kovacevic, “Voltage Phasor and local system frequency estimation using newton type algorithm,” IEEE Transactions on Power Delivery, Vol. 9, No. 3, July 1994, pp. 1368-1374.
[25] A. M. Zayezdny, Y. Adler, and I. Druckmann, “Short Time Measurement of Frequency and Amplitude in the Presence of Noise,” IEEE Transactions on Instrumentation and Measurement, Vol. 41, No. 3, June 1992, pp. 397-402.
[26] Jose A. de la O, “New Family of Digital Filters for Phasor Computation,” IEEE Transactions on Power Delivery, Vol. 15, No. 1, January 2000, pp. 86-91.
[27] K-D. Wu and H-L. Jou, “An Orthogonal Peak Detector for Multiphase Sinusoidal Signals,” IEEE Transactions on Instrumentation and Measurement, Vol. 49, No. 6, December 2000, pp. 1216-1223.
[28] S-K. Chung, “A Phase Tracking System for Three Phase Utility Interface Inverters,” IEEE Transactions on Power Electronics, Vol. 15, No. 3, May 2000, pp. 431-438.
[30] S. Lou and Z. Hou, “An Adaptive Detecting Method for Harmonic and Reactive Currents,” IEEE Transactions on Industrial Electronics, Vol. 42, No. 1, February 1995, pp. 85-89.
[31] M. Karimi-Ghartemani and M. R. Iravani, “A Signal Processing Module for Power System Applications,” IEEE Transactions on Power Delivery, Vol. 18, No. 4, October 2003, pp. 1118-26.
[32] M. R. Iravani and M. Karimi-Ghartemani, “Estimation of Instantaneous and Stationary Symmetrical Components,” IEE Proc.-Gener. Transm. Distrib, Vol. 150, No. 5, September 2003, pp. 616-622.
[33] M. Karimi-Ghartemani and M. R. Iravani, “Wide-Range, Fast and Robust Estimation of Power System Frequency,” Electric Power Systems Research, Vol. 65, 2003, pp. 109-117.

[34] M. Karimi-Ghartemani and M. R. Iravani, “A Nonlinear Adaptive Filter For On-Line Signal Analysis in Power Systems: Applications,” IEEE Transactions on Power Delivery, Vol. 17, No. 2, April 2002, pp. 617-622.
[35] M. Karimi-Ghartemani, H. Mokhtari and M. R. Iravani, “Wavelet-Based On-Line Disturbance Detection for Power Quality Applications,” IEEE Transactions on Power Delivery, Vol. 15, No. 4, October 2000, pp. 1212-1220.
[36] M. Karimi-Ghartemani and M. R. Iravani, “Robust and Frequency-Adaptive Measurement of Peak Value,” IEEE Transactions on Power Delivery, Vol. 19, No. 2, April 2004, pp. 481-489.
[37] H. Karimi, M. Karimi-Ghartemani and M. R. Iravani, “Estimation of the Frequency and Its Rate of Change for Power System Applications,” IEEE Transactions on Power Delivery, Vol. 19, No. 2, April 2004, pp. 472-480.
[38] M. Karimi-Ghartemani, H. Karimi and M. R. Iravani, “A Magnitude/Phase-Locked Loop System Based on Estimation of Frequency and In-Phase/Quadrature-Phase Amplitudes, IEEE Transactions on Industrial Electronics, Vol. 51, No. 2, April 2004, pp. 511-517.
[39] M. Karimi-Ghartemani, H. Mokhtari, M. R. Iravani and M. Sedighy, “A Signal Processing System for Extraction of Harmonics and Reactive Current of Single-Phase Systems,” IEEE Transactions on Power Delivery, Vol. 19, No. 3, July 2004, pp. 979-986.
[40] M. Karimi-Ghartemani and M. R. Iravani, “A Method for Synchronization of Power Electronic Converters in Polluted and Variable-Frequency Environments,” IEEE Transactions on Power Systems, Vol. 16, No. 3, August 2004, pp. 1263-1270.

1. A signal processor for processing signals of a system, the signal processor comprising:
A plurality of functional units, which are organized into a first, second, third and fourth functional unit groups, which functional units are driven by an error signal, and whose functions are to estimate parameters and to synthesize signals associated with a first input signal, wherein said first input signal is an external three-phase electrical signal measured and scaled for processing, and wherein said error signal is the difference between said first input signal and a first output signal, said first output signal being an internal signal representing the synthesized fundamental component of said first input signal;
The first functional unit group includes one or more circuit components and is operable to estimate the magnitudes of the instantaneous symmetrical or sequence components of said first input signal and synthesize said symmetrical or sequence components;
The second functional unit group includes one or more circuit components and is operable to estimate phase-angles of the instantaneous sequence components of said first input signal and synthesize sine and cosine signals to be forwarded to said first functional unit group;
The third functional unit group includes one or more circuit components and is operable to estimate the frequency of the system, which is forwarded to said second functional unit group, the second functional unit group estimating the phase-angles; and
The fourth functional unit group including an addition unit that is operable to add said instantaneous sequence components provided by said first, second and third functional unit groups and wherein the output of said addition unit constitutes said first output signal.

2. The signal processor claimed in claim 1, wherein:
(a) Each of the functional units of the first functional unit group includes a three-phase dot-product unit, a single-phase gain unit, a single-phase integration unit, and a scalar-into-vector product;
(b) Each of the functional units of the second functional unit group includes a three-phase dot-product unit, a single-phase gain unit, a single-phase addition unit, a single-phase integration unit and a sine-cosine generator;
(c) The input to each of the three-phase dot-product units of the first functional unit group consists of an error signal and a sine signal produced by the corresponding three-phase dot-product units of the second functional unit group;
(d) The input to each of the three-phase dot-product units of the second functional unit group consists of an error signal and a cosine signal produced by the corresponding three-phase dot-product units of the first functional unit group; and
(e) the inputs to the each said dot-product unit of said first functional unit group is said error signal and said sine signal generated by the corresponding functional units of the second functional unit group.

3. The signal processor claimed in claim 2, wherein:
(a) said addition unit is operable to add the output of said single-phase gain units with said estimated frequency provided by said third functional unit group; and
(b) each said sine-cosine generator is operable to generate two three-phase vectors comprising sine and cosine signals.

4. The signal processor claimed in claim 3, wherein:
(a) said third functional unit group includes a sum-of-scalar-into-vector product, a three-phase dot-product, a single-phase gain unit, a single-phase integration unit and a single-phase addition unit;
(b) said sum-of-scalar-into-vector product receives said estimated magnitudes of said sequence-components from said first functional unit group and said cosine signals generated by said second functional unit group and multiplies and adds them correspondingly; and
(c) said dot-product units receive said error signal and output of said sum-of-scalar-into-vector products, and said single-phase addition unit adds output of said single-phase gain with the nominal value of the system frequency.

5. A Three-phase Power Signal Processor (TPSP) comprising:
seven different parallel branches, which are driven by an error signal and, and whose functions are to estimate parameters and to synthesize signals associated with a first input signal, said first input signal being an external three-phase electrical signal measured and properly scaled for processing, said error signal being the difference between said first input signal and a first output signal, said first output signal being an internal signal representing the synthesized fundamental component of said first input signal; the first three branches being operable to estimate the magnitudes of the instantaneous symmetrical or sequence components of said first input signal and to synthesize those components; the second three branches being operable to estimate phase-angles of the instantaneous sequence components of said first input signal and to synthesize sine and cosine signals to be forwarded to said first three branches; the seventh branch being operable to estimate the frequency of the system which is forwarded to said second three branches which estimate phase-angles; and an addition unit which adds said instantaneous sequence components provided by said first three branches and its output constitutes said first output signal.

6. A Three-phase Power Signal Processor (TPSP) as claimed in claim 5 wherein:
each branch of said first three branches consists of a three-phase dot-product, a single-phase gain, a single-phase integration, and a scalar-into-vector product; the inputs to each said dot-product unit of said first three branches are said error signal and said sine signal generated by the corresponding branch of said second three branches; and said dot-product operation is the sum of respective multiplied elements;
each branch of said second three branches consists of a three-phase dot-product, a single-phase gain, a single-phase addition, a single-phase integration and a sine-cosine generator; the inputs to each said dot-product unit of said second three branches are said error signal and said cosine signal generated by the corresponding branch of said second three branches; said single-phase additions adds output of said single-phase gain with said estimated frequency provided by said seventh branch; and said sine-cosine generator of each said branch of said second three branches generates two three-phase vectors comprising sine and cosine signals; and
said seventh branch comprises a sum-of-scalar-into-vector products, a three-phase dot-product, a single-phase gain, a single-phase integration and a single-phase addition; said sum-of-scalar-into-vector products receives said three estimated magnitudes of said sequence-components by said first three branches and said cosine signals generated by said second three branches and multiplies and adds them correspondingly, said dot-product receives said error signal and output of said sum-of-scalar-into-vector products, and said single-phase addition adds output of said single-phase gain with the nominal value of the system frequency.

7. The Three-phase Power Signal Processor (TPSP) claimed in claim 5, wherein the values of the seven gain components are positive numbers which determine the tracking speed of the responses.

8. The Three-phase Power Signal Processor (TPSP) claimed in claim 5, wherein the TPSP further comprises low-pass filters within each of said seven parallel branches; said low-pass filters being operable to further refine said estimated parameters to provide improved tracking speed versus accuracy trade-off.

9. The Three-phase Power Signal Processor (TPSP) claimed in claim 5, wherein the TPSP is duplicated to process a second measured and properly scaled input signal; said first and second input signals represent voltage and current signals; and in addition to said outputs that each TPSP provides for said first and said second input signals, said duplicated TPSP is operable to provide the instantaneous reactive current components, power factor, real and reactive powers.

10. The Three-phase Power Signal Processor (TPSP) claimed in claim 5, wherein the TPSP is operable to calculate the instantaneous reactive currents based on decomposing the instantaneous positive-sequence components of the current signal into two components that are in-phase and orthogonal-phase with the voltage signal.

11. The Three-phase Power Signal Processor (TPSP) claimed in claims 5, wherein multiple copies of the TPSP are connected to process said input signal and provide information regarding its constituting harmonic and inter-harmonic components; and wherein by using a saturation scheme in the seventh branch, each copy of the TPSP is operable to focus on a single component, identify the single component, and estimate its signal attributes.
